(19) United States
(12) Patent Application Publication
(10) Pub. No.: US 2021/0189031 A1
(43) Pub. Date: Jun. 24, 2021

(54) BRANCHED FLUOROTHERMOPLASTS AND METHOD OF MAKING THE SAME

(71) Applicant: 3M INNOVATIVE PROPERTIES COMPANY, St. Paul, MN (US)

(72) Inventors: Klaus Hintzer, Kastl (DE); Harald Kaspar, Burgkirchen (DE); Kai Helmut Lochhaas, Neuotting (DE); Jens Schrooten, Muehldor am Inn (DE); Helmut Traunspurger, Julbach (DE); Tilman C. Zipplies, Burghausen (DE)

(21) Appl. No.: 16/756,261

(22) PCT Filed: Oct. 23, 2018
(86) PCT No.: PCT/US2018/056962

§ 371 Date: Apr. 15, 2020

Related U.S. Application Data
(60) Provisional application No. 62/577,739, filed on Oct. 27, 2017.

(51) Int. Cl. C08F 214/26

(52) U.S. Cl. CPC C08F 214/262

(57) ABSTRACT

Described herein is a fluorothermoplast with long chain branching and a method of making such a polymer using a modifier of the formula: F₂C═CF(CF₂)ₐ(O)R^{f}H wherein a is 0 or 1 and R^{f} is a linear or branched fluorinated alkylene group comprising 1 to 5 carbon atoms and optionally comprising at least one ether linkage and optionally comprising 1 or 2 hydrogen atoms. This fluorothermoplast may be processed through polymer melt processes, such as blow molding, injection molding, film extrusion, and wire extrusion. Preferably, said polymer contains structural units derived from tetrafluoroethylene and a perfluorinated olefin or ether, and comprises chain branching.

### TECHNICAL FIELD

Highly fluorinated melt-processible thermoplastic polymers are disclosed along with methods of making such polymers. These highly fluorinated melt-processible thermoplastic polymers may be processed through polymer melt processes, such as blow molding, injection molding, film extrusion, and wire extrusion.

### SUMMARY

There is a desire to identify alternative long chain branched perfluorinated thermoplasts.

In one aspect, a fluorothermoplast is provided, the fluorothermoplast is derived from
(a) tetrafluoroethylene
(b) a perfluorinated olefin, wherein the perfluorinated olefin comprises at least one of hexafluoropropylene, perfluorinated vinyl ether, or a perfluorinated allyl ether;
(c) a modifier of the formula: F₂C═CF(CF₂)ₐ(O)RfH
wherein a is 0 or 1 and Rf is a linear or branched fluorinated alkylene group comprising 1 to 5 carbon atoms and optionally comprising at least one ether linkage and optionally comprising 1 or 2 hydrogen atoms.

In another aspect, a method of making a fluorothermoplast is provided, the method comprising:
(a) polymerizing tetrafluoroethylene and a perfluorinated olefin in an aqueous solution comprising a fluorinated emulsifier, wherein the perfluorinated olefin comprises at least one of hexafluoropropylene, perfluorinated vinyl ether, or a perfluorinated allyl ether to form the fluorothermoplast;
(b) at least semi-continuously adding a modifier during the polymerization, wherein the modifier is of the formula: F₂C═CF(CF₂)ₐ(O)RfH wherein a is 0 or 1 and Rf is a linear or branch fluorinated alkyl group having at most 1 or 2 hydrogen atoms and optionally comprising an ether linkage and wherein Rf comprises at least one and no more than 5 carbon atoms; and
(c) isolating the fluorothermoplast; and
(d) optionally, post-fluorinating the isolated fluorothermoplast.

The above summary is not intended to describe each embodiment. The details of one or more embodiments of the invention are also set forth in the description below. Other features, objects, and advantages will be apparent from the description and from the claims.

### BRIEF DESCRIPTION OF THE DRAWINGS

FIG. 1 is plot of the complex modulus (G*) versus frequency (ω) for Examples 1-4 and Comparative Examples 1, 4 and 5 of the present disclosure;

FIG. 2 is plot of the phase angle (δ) versus the frequency times the zero shear rate (η₀) for Examples 1-4 and Comparative Examples 1 and 5 of the present disclosure; and

FIG. 3 is plot of a normalized phase angle (δₗᵢₙ/δ) versus the frequency times the zero shear rate (η₀) for Examples 1-4 and Comparative Examples 1 and 5 of the present disclosure.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B);

“backbone” refers to the main continuous chain of the polymer;

“copolymer” refers to a polymer derived from two or more different monomers and includes terpolymers, quadpolymers, etc.;

“interpolymerized” refers to monomers that are polymerized together to form a polymer backbone;

“monomer” is a molecule which can undergo polymerization which then form part of the essential structure of a polymer;

“monomeric unit” is a divalent repeating unit derived from a monomer;

“perfluorinated” means a group or a compound derived from a hydrocarbon wherein all hydrogen atoms have been replaced by fluorine atoms. A perfluorinated compound may however still contain other atoms than fluorine and carbon atoms, like oxygen atoms, chlorine atoms, bromine atoms and iodine atoms; and

“polymer” refers to a macrostructure derived from a plurality of repeating monomeric units having a number average molecular weight (Mn) of at least 50,000 dalton, at least 100,000 dalton, at least 300,000 dalton, at least 500,000 dalton, at least, 750,000 dalton, or even at least 1,000,000 dalton and not such a high molecular weight as to cause premature gelling of the polymer such as up to 1,500,000 dalton.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

It is known in the polyolefin arts that the rheological behavior of the polymers is based on the chain length, chain length distribution, and the architecture of the polymer as opposed to the chemical composition. For example, various types of polyethylene are known in the art: high density polyethylene (HDPE), low density polyethylene (LDPE) and linear low density polyethylene (LLDPE). Although each of these polymer classes comprise the ethylene monomeric unit, they have different processing and mechanical properties based on how they are polymerized and the architecture of the resulting polymer. For example, low density polyethylene is a highly branched polymer comprising long-chain branches, short chain branches, and a broad molecular weight distribution. High-density polyethylene shows a lower degree of long-chain branching compared to low density polyethylene, while linear low density polyethylene, is a substantially linear polymer with some short chain branching originating from the use of a α-olefin comonomer. Linear low density polyethylene has a more narrow molecular weight distribution leading to a low structural viscosity. A low structural viscosity means that before meeting the critical shear rate, the viscosity does not substantially change (i.e., the slope of viscosity over shear rate is about 1) when the shear rate is increased. A low structural viscosity leads to constraints with respect to melt-processing. For example, increasing the extrusion rate to increase throughput can lead to melt defects such as melt fracture.

In order to increase throughput, it would be advantageous to identify a polymer having the same composition and melt flow index as a given linear polymer, but having melt fracture occur at a higher shear rate. Such polymers include those with long chain branching. The presence of long chain branching (for example having side chains comprising greater than 100 carbon atoms in length) can be especially helpful for polymer melt processes, such as blow molding, injection molding, film extrusion, and wire extrusion.

Post-fluorination can be applied to highly fluorinated polymers to improve the chemical and/or thermal stability of the polymer. During post-fluorination, groups such as —H, —Cl, —Br, and —I are replaced with fluorine atoms and unstable end groups such as carboxylic acid end groups, —COF, amide groups, and hydroxide group, are converted to more stable end groups such as —CF₃.

U.S. Pat. No. 6,927,265 (Kaspar et al.) teaches the polymerization of fluorinated monomers in the presence of a modifier to form a long-chain branched fluoropolymer which has improved processing characteristics. The modifier is (i) an olefin having a bromine or iodine atom bonded to a carbon of the double bond of the olefin or (ii) a fluorinated olefin with a perfluorinated divalent group containing a terminal bromine.

As shown in the Comparative Examples of the present disclosure, a tetrafluoroethylene copolymer is prepared with brominated modifier, 1-bromo-2,2-difluoroethylene (BDFE). The resulting polymer has a melt flow index (MFI) of 22 g/10 min. When the tetrafluoroethylene copolymer is post-fluorinated, the MFI decreases to 13.4 g/10 min, which is about a 2-fold change in MFI. This change in the MFI of the fluoropolymer during the work-up can make the fluoropolymer difficult to handle from a manufacturing standpoint, because a slight change in MFI during one process step can be amplified following a subsequent process.

Thus, the present application is directed toward a highly fluorinated polymer, specifically fluorothermoplasts. As used herein, a fluorothermoplast is a melt-processible thermoplastic fluoropolymer which is crystalline and has a clearly detectable and prominent melting point. Typically, the melting point is between 100° C. and 320° C. depending on the monomer composition of the fluorothermoplast. Melt-processible means the fluoropolymers have an appropriate melt-viscosity that they can be melt-extruded at standard temperatures used for melt-processing. Melt processing typically is performed at a temperature from 180° C. to 400° C., although optimum operating temperatures are selected depending upon the melting point, melt viscosity, and thermal stability of the polymer and also the type of extruder used. The fluorothermoplasts of the present disclosure, comprise long chain branching (e.g., making it easier to melt-process), which is more robust with respect to less variation in the MFI of the fluoropolymer during subsequent work-up steps.

The present application utilizes a partially fluorinated ether olefin as a branching modifier. The modifier is shown in formula I:

F₂C═CF(CF₂)ₐ(O)RfH (I)

wherein a is 0 or 1. Rf is a linear or branched fluorinated alkylene group comprises 1, 2, 3, 4, or 5 carbon atoms, optionally comprising at least one ether linkage and optionally comprising 1 or 2 hydrogen atoms.

The modifier of Formula I may be an allyl ether (a=1) or a vinyl ether (a=0) compound.

In one embodiment, Rf is a linear divalent carbon-containing group, such as —CF₂—, —CF₂CF₂—, —CF₂CF₂CF₂—, —CF₂CF₂CF₂CF₂—, and —CF₂CF₂CF₂CF₂CF₂—.

In one embodiment, Rf is a branched divalent carbon-containing group, such as —C(CF₃)F—, —CF₂C(CF₃)F—, and —CF₂C(CF₃)FCF₂—.

In one embodiment, Rf is a divalent carbon-containing group comprises one or two ether linkages, such as —CF₂OCF₂—, —CF₂CF₂OCF₂CF₂—, and —CF₂OCF₂O CF₂—.

The divalent Rf group may comprise at most one or two hydrogen atoms, however, as the fluorothermoplasts disclosed herein are typically post-fluorinated, the presence of excess hydrogen in the fluoropolymer prior to post-fluorination should be kept to a minimum. Thus, in one embodiment, the divalent Rf group is perfluorinated.

Exemplary modifier of formula (I) include: F₂C═CFO—CHF₂; F₂C═CFO—CF₂—CHF₂; F₂C═CFO—CF₂—CF₂—CHF₂; F₂C═CFO—CF₂—CF₂—CF₂—CHF₂; F₂C═CFO—CF₂—CF₂—CF₂—CF₂—CHF₂; F₂C═CFCF₂O—CHF₂; F₂C═CFCF₂O—CF₂—CHF₂; F₂C═CFCF₂O—CF₂—CF₂—CHF₂; F₂C═CFCF₂O—CF₂—CF₂—CF₂—CHF₂; F₂C═CFCF₂O—CF₂—CF₂—CF₂—CF₂—CHF₂; F₂C═CFO—CF₂—CF₂—O—CF₂CHF₂; and F₂C═CF—CF₂—O—CF₂—CHF₂.

The efficiency of monomers to incorporate into a polymer is related to their reactivity and partial pressure. In the present disclosure, the modifier is incorporated into the fluoropolymer during polymerization. Thus, the modifier should be gaseous to ensure incorporation into the polymer. In one embodiment, the modifier has a boiling point less than 100° C., 80° C., or even 70° C.

Without intending to be bound by theory, it is believed that during polymerization, the carbon-carbon double bond of Formula I can chain extend under free radical conditions as known in the art, while the hydrogen atom off the Rf group can undergo a free radical transfer reaction, leading to branching off the polymer backbone. The resulting radical of the side chain can then react with another macro radical or TFE (tetrafluoroethylene), resulting in long-chain branching of the fluoropolymer.

The fluorothermoplast of the present disclosure are highly fluorinated polymers. As used herein, highly fluorinated refers to the polymer comprising at least 65%, 70%, or even 72% fluorine and at most 76% fluorine on a weight basis compared to the total weight of the fluoropolymer.

Fluorothermoplasts of the present disclosure are derived from TFE. Exemplary highly fluorinated TFE-containing polymers include fluorinated ethylene propylene (FEP) and perfluoroalkoxy alkane (PFA).

In the case of FEP, TFE is copolymerized with hexafluoropropylene (HFP). Typically in FEP, at least 70, 75, 80, or even 82 wt % of TFE and at most 86, 88, or even 90 wt % of TFE is used and at least 10, or even 12 wt % of HFP and at most 15, 18, 20, 25, or even 30 wt % of HFP is used relative to the total polymer weight. FEP may comprise low amounts (e.g., less than 5, 2, or even 1 wt %) of additional monomers, such as perfluoro ether monomers as described in Formula II below. In one embodiment, the FEP copolymer consists essentially of units derived from TFE and HFP, wherein “consisting essentially of” refers to the absence of other comonomers, or the presence of units derived from other comonomers of less than 1.0% by weight, preferably less than 0.1% by weight.

In the case of PFA, TFE is polymerized with a perfluoroether comonomer. The perfluoroether comonomer may be a perfluoroalkyl vinyl ether monomer and/or a perfluoroalkyl allyl ether monomer. Such perfluoro ether monomers are of Formula II

CF₂═CF(CF₂)_{b}O(R_{f″}O)ₙ(R_{f′}O)ₘR_{f} (II)

where R_{f″} and R_{f′} are independently linear or branched perfluoroalkylene radical groups comprising 2, 3, 4, 5, or 6 carbon atoms, m and n are independently an integer selected from 0, 1, 2, 3, 4, 5, 6, 7, 8, 9, and 10, and R_{f} is a perfluoroalkyl group comprising 1, 2, 3, 4, 5, or 6 carbon atoms. Exemplary perfluoro ether monomers include: perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, perfluoro-methoxy-methylvinylether (CF₃—O—CF₂—O—CF═CF₂), and CF₃—(CF₂)₂—O—CF(CF₃)—CF₂—O—CF(CF₃)—CF₂—O—CF═CF₂, perfluoro (methyl allyl) ether (CF₂═CF—CF₂—O—CF₃), perfluoro (ethyl allyl) ether, perfluoro (n-propyl allyl) ether, perfluoro-2-propoxypropyl allyl ether, perfluoro-3-methoxy-n-propylallyl ether, perfluoro-2-methoxy-ethyl allyl ether, perfluoro-methoxy-methyl allyl ether, and CF₃—(CF₂)₂—O—CF(CF₃)—CF₂—O—CF(CF₃)—CF₂—O—CF₂CF═CF₂.

Typically in PFA, at least 80, 85, 90, 92 or even 94 wt % of TFE and at most 98, 99, or even 99.5 wt % of TFE is used and at least 2, or even 4 wt % of perfluoro ether monomer and at most 6, 8, 10, 15, or even 20 wt % of the perfluoro ether monomer is used relative to the total polymer. PFA may comprise low amounts (e.g., less than 10, preferably less than 6 wt %, more preferably less than 2 wt %) of additional monomers, such as HFP. In one embodiment, the PFA copolymer consists essentially of units derived from TFE and the one or more perfluoro ether monomers, wherein “consisting essentially of” refers to the absence of other comonomers, or the presence of units derived from other comonomers of less than 1.0% by weight, preferably less than 0.1% by weight.

In one embodiment, the fluorothermoplast is derived from the monomers consisting essentially of the modifier, tetrafluoroethylene and the perfluorinated olefin. In one embodiment, the fluorothermoplast is derived from the monomers consisting essentially of the modifier, tetrafluoroethylene, hexafluoropropylene, and a perfluorinated ether monomer.

Other monomers known in the art can be used in the polymerization, such as partially fluorinated monomer (e.g., vinylidene fluoride); nonfluorinated monomer (e.g., ethylene); and chlorine-, bromine-, iodine-containing monomers (e.g., chlorotrifluoroethylene or cure-site monomers). However, typically, these types of monomers are avoided to minimize post-fluorination treatment time and the consumption of fluorine.

The fluorothermoplasts disclosed herein can be obtained with any of the known polymerization techniques including solution polymerization and suspension polymerization. The fluorothermoplasts are preferably made through an aqueous emulsion polymerization process, which can be conducted in a known manner. The reactor vessel for use in the aqueous emulsion polymerization process is typically a pressurizable vessel capable of withstanding the internal pressures during the polymerization reaction. Typically, the reaction vessel will include a mechanical agitator, which will produce thorough mixing of the reactor contents and heat exchange system. Any quantity of the fluoromonomer(s) may be charged to the reactor vessel. The monomers may be charged batchwise or in a continuous or semi-continuous manner. By semi-continuous is meant that a plurality of batches of the monomer are charged to the vessel during the course of the polymerization. The independent rate at which the monomers are added to the kettle will depend on the consumption rate of the particular monomer with time. Preferably, the rate of addition of monomer will equal the rate of consumption of monomer, i.e. conversion of monomer into polymer. In the present disclosure, the modifier of Formula I is used in an amount of at least 0.01, 0.05, or even 0.1% by weight versus the total polymer weight; and at most 0.5, 0.75, 1.0, or even 1.5% by weight versus the total polymer weight. The modifier of Formula I may be added to the polymerization vessel in a continuous or semi-continuous manner during the course of the polymerization. The modifier may be fed to the polymerization from a separate inlet or storage cylinder. Alternatively, a mixture of the modifier with a perfluorinated monomer may be used to feed the modifier to the polymerization. The latter method may provide improved homogeneous incorporation of the modifier into the polymer leading to a more uniform distribution of long chain branches. Suitable perfluorinated monomers with which the modifier can be admixed to feed to the polymerization include fluorinated olefins such as TFE, HFP and perfluoro ether monomers such as perfluoromethyl vinyl ether.

The reaction kettle is charged with water, the amounts of which are not critical. To the aqueous phase there is generally also added the fluorinated surfactant, typically a non-telogenic fluorinated surfactant. Such fluorinated surfactant is typically used in amount of 0.01% by weight to 1% by weight. Suitable fluorinated surfactants include any fluorinated surfactant commonly employed in aqueous emulsion polymerization. Particularly preferred fluorinated surfactants are those that correspond to the general formula:

Y—R_{f}—Z-M

wherein Y represents hydrogen, Cl or F; R_{f} represents a linear or branched partially fluorinated alkylene having 4 to 10 carbon atoms and optionally comprising catenary oxygen atoms; Z represents COO⁻ or SO₃⁻ and M represents a hydrogen ion, an alkali metal ion or an ammonium ion. Exemplary fluorinated emulsifiers may be of the general formula:

[R_{f}—O-L-COO-]ⱼXⁱ⁺

wherein L represents a linear or branched partially or fully fluorinated alkylene group or an aliphatic hydrocarbon group, R_{f} represents a linear or branched partially or fully fluorinated aliphatic group or a linear or branched partially or fully fluorinated group interrupted with one or more oxygen atoms, Xⁱ⁺ represents a cation having the valence i and i is 1, 2 or 3. In one embodiment, the emulsifier is selected from CF₃—O—(CF₂)₃—O—CHF—CF₂—COOH and salts thereof. Specific examples are described in U.S. Pat. No. 7,671,112 (Hintzer et al.), which is incorporated herein by reference. Exemplary emulsifiers include: CF₃CF₂OCF₂CF₂OCF₂COOH, CF₃—O—(CF₂)₃—O—CFH—CF₂—COONH₄, CHF₂(CF₂)₅COOH, CF₃(CF₂)₆COOH, CF₃O(CF₂)₃OCF(CF₃)COOH, CF₃CF₂CH₂OCF₂CH₂OCF₂COOH, CF₃O(CF₂)₃OCHFCF₂COOH, CF₃O(CF₂)₃OCF₂COOH, CF₃(CF₂)₃(CH₂CF₂)₂CF₂CF₂CF₂COOH, CF₃(CF₂)₂CH₂(CF₂)₂COOH, CF₃(CF₂)₂COOH, CF₃(CF₂)₂OCF(CF₃)CF₂OCF(CF₃)COOH, CF₃(CF₂)₂(OCF₂CF₂)₄OCF(CF₃)COOH, CF₃OCF₂CF(CF₃)OCF(CF₃)COOH, C₃F₇OCF(CF₃)COOH, CF₃CF₂O(CF₂CF₂O)₃CF₂COOH, and their salts.

The aqueous emulsion polymerization may be initiated with a free radical initiator or a redox-type initiator. Any of the known or suitable initiators for initiating an aqueous emulsion polymerization of TFE can be used. Suitable initiators include organic as well as inorganic initiators. Exemplary inorganic initiators include: ammonium- alkali- or earth alkaline salts of persulfates, permanganic or manganic acids. A persulfate initiator, e.g. ammonium persulfate (APS), may be used on its own or may be used in combination with a reducing agent. The reducing agent typically reduces the half-life time of the persulfate initiator. Additionally, a metal salt catalyst such as for example copper, iron, or silver salts may be added. In one embodiment, the polymerization is done in the absence of alkali metals such as potassium and sodium.

The amount of the polymerization initiator may suitably be selected, but it is usually from 2 to 600 ppm, based on the mass of water used in the polymerization. The amount of the polymerization initiator can be used to adjust the MFI of the fluorothermoplasts. If small amounts of initiator are used, a low MFI may be obtained. In one embodiment, a chain transfer agent is not used. However, the MFI can also, or additionally, be adjusted by using a chain transfer agent. Typical chain transfer agents include methane, ethane, propane, butane, alcohols such as ethanol or methanol or ethers such as, but not limited to, dimethyl ether, tertiary butyl ether, methyl tertiary butyl ether. The amount and the type of perfluorinated comomonomer may also influence the melting point of the resulting polymer.

The aqueous emulsion polymerization system may further comprise auxiliaries, such as buffers because some initiators are most effective within certain pH ranges, and complex-formers. It is preferred to keep the amount of auxiliaries as low as possible to ensure a higher colloidal stability of the polymer latex.

The polymerization is preferably carried out by polymerizing TFE and the comonomers simultaneously. Typically, the reaction vessel is charged with the ingredients and the reaction is started by activating the initiator. In one embodiment, the TFE and the comonomers are then continuously fed into the reaction vessel after the reaction has started. They may be fed continuously at a constant TFE:comonomer ratio or at a changing TFE:comonomer ratio.

In another embodiment, a seeded polymerization may be used to produce the fluorothermoplasts. If the composition of the seed particles is different from the polymers that are formed on the seed particles a core-shell polymer is formed. That is, the polymerization is initiated in the presence of small particles of fluoropolymer, typically small polytetrafluoroethylene particles that have been homopolymerized with TFE or produced by copolymerizing TFE with one or more perfluorinated comonomers as described above. These seed particles typically have an average diameter (D₅₀) of between 20 and 100 nm or 50 and 150 nm (nanometers). Such seed particles may be produced, for example, in a separate aqueous emulsion polymerization. They may be used in an amount of 20 to 50% by weight based on the weight of water in the aqueous emulsion polymerization. Accordingly, the thus produced particles will comprise a core of a homopolymer of TFE or a copolymer of TFE and an outer shell comprising a copolymer of TFE. The polymer may also have one or more intermediate shells if the polymer compositions are varied accordingly. The use of seed particles may allow a better control over the resulting particle size and the ability to vary the amount of TFE in the core or shell. Such polymerization of TFE using seed particles is described, for example, in U.S. Pat. No. 4,391,940 (Kuhls et al.) or WO03/059992 A1.

The aqueous emulsion polymerization, whether done with or without seed particles, will preferably be conducted at a temperature of at least 50° C., preferably at least 60° C. Upper temperatures may typically include temperatures of 80° C., 90° C., 100° C., 110° C., 120° C., or even 150° C.

The polymerization will preferably be conducted at a pressure of at least 0.5, 1.0, 1.5, 1.75, 2.0, or even 2.25 MPa (megaPascals); at most 2.5, 3.0, 3.5, 3.75, 4.0, or even 4.5 MPa.

The aqueous emulsion polymerization usually is carried out until the concentration of the polymer particles in the aqueous emulsion is at least 15, 20, or even 25% by weight; and at most 30, 35, 40, or even 50% by weight (also referred to as “solid content”).

In one embodiment, the average particle size of the polymer particles (i.e., primary particles) is at least 50, 100, or even 150 nm; at most 250, 275, 300, or even 350 nm (D₅₀). The particle sizes of dispersions can be determined by dynamic light scattering. During work-up these particles sizes may be further increased to the final particle sizes by standard techniques (such as, e.g., agglomeration or melt-pelletizing).

In one embodiment of the present disclosure, various additives can be added to the fluorothermoplast to modify its processability and/or final properties. Additives can include fillers, and/or colorants.

Organic and inorganic fillers such as clay, silica (SiO₂), alumina, iron red, talc, diatomaceous earth, barium sulfate, wollastonite (CaSiO₃), calcium carbonate (CaCO₃), calcium fluoride, hexagonal boron nitride, titanium oxide, iron oxide and carbon black fillers, a polytetrafluoroethylene powder, PFA (TFE/perfluorovinyl ether copolymer) powder, an electrically conductive filler, a heat-dissipating filler, and the like may be added as an optional component to a composition comprising the fluoropolymer. Those skilled in the art are capable of selecting specific fillers at required amounts to achieve desired physical characteristics in the fluoropolymer composition.

In one embodiment, the composition comprises less than 10, 5, or even 1% by weight of the inorganic filler.

For melt processing and making shaped articles, the fluorothermoplasts are used in dry form and therefore have to be separated from the dispersion. The fluorothermoplasts described herein may be collected by deliberately coagulating them from the aqueous dispersions by methods known in the art. In one embodiment, the aqueous emulsion is exposed to high shear (e.g., stirring at high shear rates or the use of a high pressure homogenizer) to deliberately coagulate the polymer. Other salt-free methods include the addition of mineral acids. If salt content is not an issue with end use applications, salts can be added as coagulating agents, such as for example, chloride salts or ammonium carbonate. Agglomerating agents such as hydrocarbons like toluenes, xylenes and the like may be added to increase the particle sizes and to form agglomerates. Agglomeration may lead to particles (secondary particles) having sizes of from about 0.5 to 5 mm, preferably 0.5 to 1.5 mm.

Drying of the coagulated and/or agglomerated polymer particles can be carried out at temperatures of, for example, from 100° C. to 300° C. Particle sizes of coagulated particles can be determined by light microscopy. The average particle sizes can be expressed as number average by standard particle size determination software. The particle sizes may be further increased by melt-pelletizing. The melt pellets may have a particle size (longest diameter) of from at least 2 mm, typically from about 2 to about 10 mm.

Preferably, the isolated fluorinated polymers disclosed herein are post-fluorinated, resulting in a perfluorinated polymer, wherein the fluorothermoplast is substantially free of carbon-hydrogen bonds (less than 100, 50, 25, or even 10 carbon-hydrogen bonds per 1 million carbon atoms) and substantially free of thermally unstable groups (less than 50, or even 20 thermally unstable groups per 1 million carbon atoms). Thermally unstable groups include: carboxylic acid groups and their salts, COF groups, amide groups, and —CF₂CH₂OH.

Post-fluorination of the fluorothermoplast may be carried out according to any of the procedures known in the art. For example, post-fluorination may be carried out by any fluorine radical generating compound, but is preferably carried out with fluorine gas. Thus, the fluorothermoplast may be contacted with the fluorine gas, which is preferably diluted with an inert gas such as nitrogen. Typical fluorination conditions include the use of a fluorine/inert gas ratio of 1 to 100 volume %, typically 5 to 25%, a temperature of between 100 and 250° C. and a gas pressure of 0.5 to 10 bar absolute. Preferably, the fluorothermoplast is agitated during fluorination. After the fluorination, the fluorothermoplast is typically sparged with an inert gas such as nitrogen to reduce the level of extractable fluorides in the fluorothermoplast to a desired level, e.g. less than 3 ppm (parts per million) by weight, preferably less than 1 ppm by weight.

Preferably, the post-fluorination is conducted under conditions sufficient such that not more than 50, preferably not more than 30 and most preferably not more than 10 unstable end groups per million carbon atoms are present in the fluorothermoplast. The amount of end groups can be determined by IR spectroscopy as described for example in EP 226 668 B1 (Buckmaster et al.).

In one embodiment, the fluorothermoplast is substantially free of iodine, bromine and chlorine. In other words, less than 500, 100, 50, or even 10 parts per million of iodine, bromine and chlorine in the fluorothermoplast when studied by elemental analysis. The low amount of iodine, bromine, and chlorine is a result of post fluorination and limiting the use of cure site monomers comprising these halogen and/or chain transfer agents comprising these halogens during polymerization. In one embodiment, the metal ion content of the resulting polymer may be low. For example, in one embodiment, the fluorothermoplast is substantially free of (less than 500 ppb (parts per billion), or even less than 100 ppb) of alkali and alkaline earth metal ions (such as sodium and potassium). The metal ion content can be determined by combustion and induction coupled plasma (ICP) analysis.

In one embodiment, the fluorothermoplasts of the present disclosure (either before or after post fluorination) have an MFI (melt flow index) at 372° C./5 kg of 0.5 to 45 g/10 min, preferably 1 to 35 g/10 min, more preferably 1.5 to 35 g/10 min.

Indications that the fluoropolymers disclosed herein comprise long chain branching were found by examining the rheology data obtained on the melt of the fluorothermoplasts. The fluorothermoplasts properties as a function of temperature, frequency, stress, and time were investigated to determine the storage modulus (G′) and loss modulus (G″).

Dynamic mechanical testing can be conducted using a parallel plate geometry in an oscillatory shear mode with stress and strain oscillating sinusoidally at a controlled frequency, (herein expressed as an angular frequency, ω, in radians/sec), where one cycle of oscillation is 27 radians. As described in standard viscoelasticity references (e.g. “Viscoelastic Properties of Polymers,” J. D. Ferry, 3^{rd} edition, John Wiley and Sons, 1980), the material property parameters, complex modulus (G*), and phase angle (δ) were determined. G* is the ratio of peak-to-peak stress amplitude to peak-to-peak strain amplitude and the phase angle is the shift between the phase of the stress wave and that of the strain wave, expressed either in degrees or radians. One full cycle of oscillation is 360 degrees or 27 radians. From these parameters, the parameters G′, G″ and tan δ are derived as follows:

G′=G*cos δ

G″=G*sin δ

tan δ=tangent of δ which is also equal to G″/G′

In one embodiment, the log of the complex modulus (G*) can be plotted versus the log of the frequency (ω) for the fluoropolymer. Polymers having long chain branching appear to have a more shallow slope (i.e., a slope less than 0.90, 0.85, or even 0.80) than their linear counterparts (e.g., polymers made without the modifier) when studied in a given G* range (e.g., 4×10³ Pa to 4×10⁴ Pa). However, this shallow slope effect appears effective for polymers having a MFI less than 50 or even 40 g/10 minutes when measured at 372° C. with a 5.0 kg weight. In one embodiment, the fluorinated thermoplastic polymer of the present disclosure, when the log of the complex modulus G*(ω) is measured at 372° C. over 4×10³ Pa to 4×10 4 Pa is plotted versus the log of the angular frequency (ω) for the fluorinated thermoplastic polymer having an MFI less than 50 g/10 min, the slope of the log of the complex modulus G*(ω) versus the log of angular frequency (ω) is no more than 0.90 (dlogG*(ω))/dlogω).

In another embodiment, long chain branching may be observed by examining the phase angle of the polymers of the present disclosure versus polymers made not using the modifier. For example, by fitting the data from a viscosity versus strain plot to a Carreau fit, the zero shear viscosity (η₀) can be determined. The phase angle (δ) versus the frequency times the zero shear rate can be plotted for the sample. In one embodiment, taking the first derivative of the resulting curve could be used to evaluate the relaxation exponent n of the polymer, wherein n=δ_{c}/90° and δ_{c} is the phase angle at gel point. In one embodiment, the fluorothermoplast has a relaxation exponent from 0.3 to 0.85.

Applicants have derived a set of equations for normalizing the phase angle of the fluoropolymers of the present disclosure with that of a linear polymer.

First, an equation was derived to calculate the phase angle of a linear polymer based on the zero shear viscosity (η₀) and angular frequency. The equation is shown below as equation 1:

$${δ}_{lin .} ( {η}_{0} \cdot ω ) = 90 / ( 1 + {( \frac{lg ( {η}_{0} \cdot ω )}{5.906} )}^{b} ) \qquad Equation 1$$

Herein, the exponent b is a shape parameter which is related to the dispersity Ð(≡M_{w}/Mₙ) of the unbranched primary population by equation 2

$$b = {c}_{1} \times exp ( \frac{{c}_{2}}{D - {c}_{3}} ) \qquad Equation 2$$

The parameters Ð=1.72, c₁=3.6127, c₂=0.2953 and c₃=1.0727 are used.

Zero shear viscosities, η₀, were extrapolated from the complex viscosity function η*(ω) of the obtained dynamic mechanical master curve using the 4 parameter Carreau fit function.

Once calculating δ_{lin.}(η₀.ω), the calculated δ_{lin.}(η₀.ω) is divided by the observed δ of the polymer (taken from the rheometer) and is plotted versus η₀.ω. This plot can be fit to Equation 3

$$\frac{{δ}_{lin .} ( {η}_{0} \cdot ω )}{{δ}_{br .} ( {η}_{0} \cdot ω )} = 1 - \frac{a \cdot ( lg ( {η}_{0} \cdot ω ) - {x}_{0} )}{{σ}^{2}} \cdot exp ( - 0 , 5 \cdot {( \frac{l g ( {η}_{0} \cdot ω ) - {x}_{0}}{σ} )}^{2} ) \qquad Equation 3$$

where the parameters α and σ define the amplitude and the breadth of the peak and x₀=lg(η₀.ω) locates the peak position where the function passes the midpoint of δ_{lin.}(η₀.ω)/δ_{br.}(η₀.ω)=1. For linear polymers, the ratio of δ_{lin.}(η₀.ω)/δ_{br.}(η₀.ω) remains very close to 1. This equation allows for the normalization of the phase angle of the polymers of the present disclosure and is independent of the melt viscosity.

The relaxation times τ₀ of the long-chain branched macromolecules are transformed into the mass-average molar masses λ of the branched sub-units by equation 4, and the mass fractions of long-chain branched (LCB) macromolecules are derived from the peak amplitudes α by equation 5.

$$\begin{matrix}{τ}_{0} = \frac{1}{{ω}_{n}} = 7.63 \times {10}^{- 22} \cdot {λ}^{3.6} & Equation 4 \\ LCB fraction [ wt \% ] = 6.95 \times {α}^{1 / 2} & Equation 5\end{matrix}$$

In one embodiment, the fluorinated thermoplastic polymer of the present disclosure has a LCB fraction of at least 2 wt % and at most 10 wt %.

The level of long chain branches of the fluorothermoplasts can be readily and reproducibly controlled by varying the amount of the modifier used. Thus, in general, a lower amount of the modifier will produce a lower amount of branching and a larger amount of modifier will increase the amount of branching. It should however be avoided to use a too large amount of the modifier as this may result in a brittle and gelled product. The appropriate amounts of modifier needed, can be readily established through routine experimentation. Although other factors, such as the polymerization conditions may to some extent also influence the level of long chain branches, the amount of the modifier needed will typically be not more than 0.3%, 0.4%, or even 0.5% by weight based on the total weight of monomers fed to the polymerization. A useful amount may be from 0.01% to 0.5% by weight, preferably from 0.05% to 0.45% by weight. The modifier is added at least in a semi-continuous manner (for example, continuously or added repeatedly in a batch portions) during polymerization, to ensure incorporation of the modifier throughout the polymer.

The fluorothermoplasts disclosed herein may be used in a variety of applications such as coating, molding, injection molding, and extrusion applications.

The fluorothermoplasts are suitable for making a variety of articles and are, in particular, suitable in extrusion processing to produce articles. For example, perfluorinated polymers are used as insulation for wires and cables. The rate of extrusion is limited by the physical properties of the melt. For example, extruding too fast can apply shear stress and elongation stress on the fluorinated polymer leading to defects such as unevenness or scalloping. Traditionally, one way to increase extrusion rate, while avoiding shear and elongation stress, was to use a polymer with a higher melt flow index. However, these polymers tend to have poor mechanical properties. The fluorothermoplasts of the present disclosure may present the advantage of having a high critical shear rate combined with a high elongational viscosity so that they can be rapidly processed and can be processed with high draw down ratios that may be used in wire and cable extrusion. Generally, these properties are obtained without sacrificing the mechanical properties. Furthermore because of the strain hardening properties that the fluorothermoplasts according to the disclosure may possess, any diameter fluctuations that may result at high processing speeds with a high draw down ratio in cable or wire extrusion generally disappear during the cable extrusion with the high drawing force applied to the cable or wire. This is to be contrasted with fluorothermoplasts that do not comprise long chain branching (e.g., linear polymers) in which breaking of the cable insulation would occur under high drawing forces at those spots were the cable diameter is low as a result of diameter fluctuations occurring in the drawing process.

The fluorothermoplasts discloses herein may also be suitable for blow molding applications, as a result of the high bubble stability of the fluorothermoplasts disclosed herein meaning that there is less sagging and/or bulging of the fluoropolymer melt as it is blown.

The fluorothermoplasts disclosed herein may also be suitable for film extrusion. The long chain branched fluorothermoplasts disclosed herein can have improved dimensional stability over its linear counterparts. The improved dimensional stability of the film results in minimal scalloping of the film as the polymer melt is drawn down at high rates.

The fluorothermoplasts disclosed herein may also be used in coating applications as known in the art to coat, laminate, and/or impregnate various substrates such as metals, fluoropolymer layers, and fabric.

Exemplary embodiments of the present disclosure include, but should not be limited to the following:

Embodiment 1. A fluorothermoplast derived from
(a) tetrafluoroethylene
(b) a perfluorinated olefin, wherein the perfluorinated olefin comprises at least one of hexafluoropropylene, perfluorinated vinyl ether, or a perfluorinated allyl ether;
(c) a modifier of the formula: F₂C═CF(CF₂)ₐ(O)RfH wherein a is 0 or 1 and Rf is a linear or branched fluorinated alkylene group comprising 1 to 5 carbon atoms and optionally comprising at least one ether linkage and optionally comprising 1 or 2 hydrogen atoms.

Embodiment 2. The fluorothermoplast of embodiment 1, wherein the modifier has a boiling point less than 100° C.

Embodiment 3. The fluorothermoplast of any one of the previous embodiments, wherein the fluorothermoplast is derived from at least 0.01% and at most 1% by weight of the modifier.

Embodiment 4. The fluorothermoplast of any one of the previous embodiments, wherein Rf is a linear or branched perfluorinated alkylene group comprising 1 to 5 carbon atoms and optionally comprising at least one ether linkage.

Embodiment 5. The fluorothermoplast of any one of the previous embodiments, wherein when the complex modulus G*(ω) measured at 372° C. over 4×10³ Pa to 4×10⁴ Pa is plotted versus the angular frequency (ω) for the fluorothermoplast having an MFI of less than 50 g/10 min measured at 372° C. with 5.0 kg weight, the slope of the log of the complex modulus G*(ω) versus the log of the angular frequency (ω) is no more than 0.90 (dlogG*(ω))/dlogω).

Embodiment 6. The fluorothermoplast of any one of the previous embodiments, wherein the modifier comprises at least one of:

F₂C═CFO—CHF₂

F₂C═CFO—CF₂—CHF₂

F₂C═CFO—CF₂—CF₂—CHF₂

F₂C═CFO—CF₂—CF₂—CF₂—CHF₂

F₂C═CFO—CF₂—CF₂—CF₂—CF₂—CHF₂

F₂C═CFCF₂O—CHF₂

F₂C═CFCF₂O—CF₂—CHF₂

F₂C═CFCF₂O—CF₂—CF₂—CHF₂

F₂C═CFCF₂O—CF₂—CF₂—CF₂—CHF₂

F₂C═CFCF₂O—CF₂—CF₂—CF₂—CF₂—CHF₂

F₂C═CFO—CF₂—CF₂—O—CF₂CHF₂ and

F₂C═CF—CF₂—CF₂—CHF₂.

Embodiment 7. The fluorothermoplast of any one of the previous embodiments, wherein the fluorothermoplast is not derived from a cure-site monomer comprising bromine, chlorine or iodine.

Embodiment 8. The fluorothermoplast of any one of the previous embodiments, wherein the fluorothermoplast is substantially free of bromine, chlorine and iodine.

Embodiment 9. The fluorothermoplast of any one of the previous embodiments, wherein the fluorothermoplast is a perfluoroalkoxy polymer (PFA) or a fluorinated ethylene-propylene polymer (FEP).

Embodiment 10. The fluorothermoplast of any one of the previous embodiments, wherein the fluorothermoplast consists essentially of tetrafluoroethylene, the perfluorinated olefin, and the modifier.

Embodiment 11. The fluorothermoplast of any of the previous embodiments, wherein the fluorothermoplast comprises less than 50 thermally unstable end groups per 1 million carbon atoms.

Embodiment 12. The fluorothermoplast of any of the previous embodiments, wherein the fluorothermoplast is substantially free of alkali and alkaline earth metals.

Embodiment 13. The fluorothermoplast of any one of the previous embodiments, wherein the fluorothermoplast has a LCB fraction of at least 2 and at most 10 as calculated by equation 5.

Embodiment 14. A composition comprising the fluorothermoplast of any of the previous embodiments.

Embodiment 15. The composition of embodiment 14, wherein the composition further comprises a filler.

Embodiment 16. An article comprising the composition of any of embodiments 14-15, wherein the article is an extruded article, or a blow molded article.

Embodiment 17. A perfluorinated fluorothermoplast comprising long chain branching, wherein the perfluorinated fluorothermoplast has a relaxation exponent from 0.3 to 0.85.

Embodiment 18. The perfluorinated fluorothermoplast of embodiment 17, wherein the perfluorinated fluorothermoplast comprises less than 50 thermally unstable end groups per 1 million carbon atoms.

Embodiment 19. The perfluorinated fluorothermoplast of any one of embodiments 17-18, wherein the perfluorinated fluorthermoplast is FEP or PFA.

Embodiment 20. A method of making a fluorothermoplast comprising:
(a) polymerizing tetrafluoroethylene and a perfluorinated olefin in an aqueous solution comprising a fluorinated emulsifier, wherein the perfluorinated olefin comprises at least one of hexafluoropropylene, perfluorinated vinyl ether, or a perfluorinated allyl ether to form the fluorothermoplast;
(b) at least semi-continuously adding a modifier during the polymerization, wherein the modifier is of the formula: F₂C═CF(CF₂)ₐ(O)RfH
wherein a is 0 or 1 and Rf is a linear or branch fluorinated alkyl group having at most 1 or 2 hydrogen atoms and optionally comprising an ether linkage and wherein Rf comprises at least one and no more than 5 carbon atoms; and
(c) isolating the fluorothermoplast; and
(d) optionally, post-fluorinating the isolated fluorothermoplast.

Embodiment 21. The method of embodiment 20, wherein the modifier has a boiling point less than 100° C.

Embodiment 22. The method of any one of embodiments 20-21, wherein the fluorothermoplast is derived from at least 0.01% and at most 1% by weight of the modifier.

Embodiment 23. The method of any one of embodiments 20-22, wherein the modifier comprises at least one of:

F₂C═CFO—CHF₂

F₂C═CFO—CF₂—CHF₂

F₂C═CFO—CF₂—CF₂—CHF₂

F₂C═CFO—CF₂—CF₂—CF₂—CHF₂

F₂C═CFO—CF₂—CF₂—CF₂—CF₂—CHF₂

F₂C═CFCF₂O—CHF₂

F₂C═CFCF₂O—CF₂—CHF₂

F₂C═CFCF₂O—CF₂—CF₂—CHF₂

F₂C═CFCF₂O—CF₂—CF₂—CF₂—CHF₂

F₂C═CFCF₂O—CF₂—CF₂—CF₂—CF₂—CHF₂

F₂C═CFO—CF₂—CF₂—O—CF₂CHF₂ and

F₂C═CF—CF₂—CF₂—CHF₂.

Embodiment 24. The method of any one of embodiments 20-23, wherein a cure-site monomer comprising bromine, chlorine or iodine is not used in the polymerizing.

Embodiment 25. The method of any one of embodiments 20-23, wherein the polymerizing step consists essentially of tetrafluoroethylene, the perfluorinated olefin, and the modifier.

### Examples

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Milwaukee, Wis., or may be synthesized by conventional methods.

The following abbreviations are used in this section: mL=milliliters, L=liters, g=grams, kg=kilograms, cm=centimeters, mm=millimeters, nm=nanometers, mol=mole, wt. %=percent by weight, mass %=percent by mass, s=seconds, min=minutes, h=hours, N=newtons, ° C.=degrees Celsius, rad=radians, rpm=revolutions per minute, Pa=pascal, MPa=megapascal, mW=milliWatt, and mbar=millibar.

### METHODS

Average Particle Size

The particle size determination was conducted by dynamic light scattering in accordance with ISO 13321 (1996; Photonenkorrelationsspektroskopie, PCS, Dynamisches Streulichtverfahren). A Zeta Sizer Nano S, available from Malvern Instruments Ltd., Malvern, Worcestershire, UK, equipped with a 5 mW laser operating at 633 nm was used for the analysis. The polymer dispersions were diluted with 0.01 mol/L NaC-solution prior to measurements. 12 mm square disposable cuvettes (available from Malvern Instruments Ltd) were used to mount a sample volume of about 1 mL. Data analysis was conducted using the orchestrator software “PCS Vers. 6.20” from Malvern Instruments Ltd.; automated selection of the attenuator and automated laser beam positioning (4.65 mm: center of the cell; 0.65 mm: cell wall) were both enabled. The measuring device was operated at 25° C. in 173 backscattering mode, each measurement consisting of 10 sub-runs was repeated for at least two times. The correlograms were analyzed by the unimodal method of cumulants. The D₅₀ particle sizes reported herein are reflecting an average value of the Z-average particle diameter.

End Group Analysis

Polymer end group detection was conducted in analogy to the method described in U.S. Pat. No. 4,743,658 (Imbalzano et al.). Thin films of approximately 0.50 mm were scanned on Nicolet Model 510 Fourier-transform infrared spectrometer (available from Thermo Fisher Scientific, Waltham, Mass.). 16 scans were collected before the transform is performed, all other operational settings used were those provided as default settings in the Nicolet control software. Similarly, a film of a reference material known to have none of the end groups to be analyzed was molded and scanned. The reference absorbance spectrum is subtracted from the sample absorbance, using the interactive subtraction mode of the software. The CF2 overtone band at 2365 wavenumbers is used to compensate for thickness differences between sample and reference during the interactive subtraction. The difference spectrum represents the absorbances due to non-perfluorinated polymer end groups. The number of end groups per million carbon atoms was determined via the equation: end groups/1 million carbon atoms=absorbance×CF/film thickness in mm. The calibration factors (CF) used to calculate the numbers of end groups per million carbon atoms are summarized in the following table:

| End group | Wavenumber [1/cm] | Calibration Factor (CF) |
|---|---|---|
| —COF | 1885 | 1020 |
| —CONH₂ | 3438 | 1105 |
| —COOH, isolated | 1814 | 740 |
| —COOH, associated | 1775 | 112 |

Melt Flow Index (MFI)

The melt flow index (MFI), reported in g/10 min, was measured according to ASTM D-1238-13 at a support weight of 5.0 kg and a temperature of 372° C. The MFI was obtained with a standardized extrusion die of 2.1 mm diameter and a length of 8.0 mm.

Melting Point

The melting point of the fluorothermoplastic polymer was determined using differential scanning calorimetry following a similar procedure as described in ASTM D4591-07 (2012) using a PerkinElmer Pyris 1 DSC (Waltham, Mass.) under nitrogen flow with a heating rate of 10° C./min. The reported melting points relate to the melting peak maximum.

Method for Melt Rheology Characterization

Oscillatory shear flow measurements were conducted on fluoropolymer melts using a strain controlled ARES rheometer (3ARES-13; Firmware version 4.04.00) (TA Instruments Inc., New Castle, Del.) equipped with a FRT 200 transducer with a force range of up to 200 g. Dynamic mechanical data were recorded in nitrogen atmosphere in frequency sweep experiments using a 25 mm parallel plate geometry and a plate to plate distance of usually 1.8 mm was realized. Individual frequency sweeps were recorded at a temperature of 372° C. The thermal control of the oven was operated using the sample/tool thermal element. A strain typically ascending from 1 to 20% was applied while the shear rate was descended from 100 rad/s to typically 0.1 rad/s. When appropriate, additional frequency sweeps were also recorded at a temperature of 340° C., 300° C., 280° C. and in super-cooled melt at 260° C.

Method for Long Chain Branching Calculation

Using the time-temperature-superposition (TTS) tool provided by the orchestrator software (version 7.0.8.13) on the rheometer, the individual frequency sweeps were combined to one master curve, wherein T=372° C. was selected as the reference temperature. Zero shear viscosities η₀, reported in units of Pa×s, were extrapolated from the complex viscosity function η*(ω) of the obtained dynamic mechanical master curve using the 4 parameter Carreau fit function provided by the orchestrator software. The shear thinning of the FEP and PFA copolymers was quantified by the slope of the complex modulus G*(ω) at T=372° C. plotted versus the angular frequency ω in double logarithmic scale. The slope dlg{G*(ω)}/dlg{ω} was extracted by a linear regression in the range of 4000 Pa G*(ω) 40000 Pa, wherein the correlation coefficient was usually 0.999≤r²≤0.9999. The so-obtained results are summarized in the following tables. And further, the long-chain branches were quantified from the dynamic-mechanical raw data by a procedure consisting of the following steps:

(1) The angular frequencies ω are normalized by the zero shear viscosity η₀.

(2) The phase angle δ_{br.}(η₀.) of the long-chain branched polymer is compared with the normalized phase angle δ_{lin.}(η₀.ω) of a reference polymer with a linear chain topology and of the same zero shear viscosity η₀. The term δ_{lin.}(η₀.ω) was calculated by an expression given by equation 1:

$${δ}_{lin .} ( {η}_{0} \cdot ω ) = 90 / ( 1 + {( \frac{lg ( {η}_{0} \cdot ω )}{5.906} )}^{b} ) \qquad Equation 1$$

Herein, the exponent b is a shape parameter which is related to the dispersity Ð (≡M_{w}/Mₙ) of the unbranched primary population by equation 2 (└=1.72), with the parameters c₁=3.6127, c₂=0.2953 and c₃=1.0727 being used:

$$b = {c}_{1} \times exp ( \frac{{c}_{2}}{D - {c}_{3}} ) \qquad Equation 2$$

With the thus-obtained expressions, the ratio δ_{lin.}(η₀.ω)/δ_{br.}(η₀.ω) was formed. With this procedure it is believed, without being bound to theory, that the contributions of the long-chain branched macromolecules to the dynamic-mechanical data are separated from the ones of linear chain topology with the same η₀.

(3) For long-chain branched polymers, relaxation time distribution of the long-chain branched polymer segments is mathematically approximated by a Gaussian type function as shown in equation 3:

$$\frac{{δ}_{lin .} ( {η}_{0} \cdot ω )}{{δ}_{br .} ( {η}_{0} \cdot ω )} = 1 - \frac{a \cdot ( lg ( {η}_{0} \cdot ω ) - {x}_{0} )}{{σ}^{2}} \cdot exp ( - 0 , 5 \cdot {( \frac{l g ( {η}_{0} \cdot ω ) - {x}_{0}}{σ} )}^{2} ) \qquad Equation 3$$

Herein, the parameters α and σ define the amplitude and the breadth of the peak and x₀=lg(η₀·ω₀) locates the peak position where the function passes the midpoint of δ_{lin.}(η₀·ω)/δ(η₀·ω)=1. A user defined fit routine operating under the software SigmaPlot 12.5 (Systat Software, Inc.; San Jose/CA, USA) was used to determine the 3 fit parameters (α, σ, and x₀), which are reported in the following tables.

(4) The relaxation times to of the long-chain branched macromolecules were transformed into the mass-average molar masses λ of the branched sub-units by equation 4 below and the weight percent of long-chain branched macromolecules were derived from equation 5 using the peak amplitude (α) taken from Equation 3.

$$\begin{matrix}{τ}_{0} = \frac{1}{{ω}_{n}} = 7.63 \times {10}^{- 22} \cdot {λ}^{3.6} & Equation 4 \\ LCB fraction [ wt \% ] = 6.95 \times {α}^{1 / 2} & Equation 5\end{matrix}$$

### Example 1 (EX-1)

A copolymer of TFE, HFP, and HPPVE-1 was prepared as follows: A polymerization kettle with a total volume of 52.5 L equipped with an impeller agitator system was charged with 28.0 L deionized water, 50 g of a 25 mass % aqueous solution of ammonium hydroxide, and 465 g of a 30 mass % aqueous solution of CF₃—O—(CF₂)₃—O—CFH—CF₂—COONH₄ (prepared as described in “Preparation of Compound 11” in U.S. Pat. No. 7,671,112). The oxygen-free kettle was then heated up to 70° C. and the agitation system was set to 240 rpm. The kettle was charged with 14 mbar (1.4 kPa) ethane, 1.3 kg hexafluoropropylene (HFP) to a pressure of 10.1 bar (1.01 MPa) absolute, and with 625 g tetrafluoroethylene (TFE) to 17.0 bar absolute reaction pressure. The polymerization was initiated by the addition of 62 g ammonium persulfate. As the reaction started, the reaction temperature of 70° C. was maintained and the reaction pressure of 17.0 bar absolute was maintained by feeding TFE, HFP, and HPPVE-1 (F₂C═CFOCF₂CF₂CHF₂, available from Anles (St. Petersburg, Russia)) into the gas phase with monomer mass feed ratios m_{HFP}/M_{TFE} of 0.120 and M_{HPPVE-1}/M_{TFE} Of 0.001. When a total feed of 11.0 kg TFE was reached in 255 min, the feed of the monomers was interrupted by closing the monomer valves. Then the reactor was vented and flushed with N₂ in three cycles.

The so-obtained 40.4 kg polymer dispersion having a solid content of 30.5 mass % was removed at the bottom of the reactor and stirred in the presence of Dowex Monosphere 650C cation exchange resin (Dow Chemical Co., Midland, Mich.), which was filtered off afterwards. The dispersion was subsequently agglomerated and dried for 16 h at 120° C. The thus obtained 12.3 kg polymer showed the physical properties and long-chain branching values given in Table 1.

### Example 2 (EX-2)

A copolymer of TFE, HFP, and HPPVE-1 was prepared as follows:

A copolymer was prepared in the same manner as in Example 1 except that the HPPVE-1/TFE feed mole fraction was adjusted to m_{HPPVE-1}/M_{TFE} of 0.003. The physical properties and long-chain branching values of the dry polymer agglomerate are shown in Table 1 below.

### Example 3 (EX-3)

A copolymer of TFE, HFP, and HPPVE-1 was prepared as follows:

A copolymer was prepared in the same manner as in Example 1 except that the HPPVE-1/TFE feed mole fraction was adjusted to m_{HPPVE-1}/M_{TFE} of 0.006. The polymerization took 254 min. The dried polymer agglomerate had an MFI (372/5) of 26 g/10 min, and was subjected to post-fluorination. The post fluorination procedure is described in Comparative Example 2. The physical properties and long-chain branching values of the thus-obtained polymer agglomerate are shown in Table 1 below.

### Comparative Example 1 (CE-1)

A commercially available FEP polymer. The physical properties and long-chain branching values are shown in Table 1.

TABLE 1

| | EX-1 | EX-2 | EX-3 | CE-1 |
|---|---|---|---|---|
| Melting point [° C.] | 255 | 256 | 256 | 255 |
| MFI(372/5) [g/10 min] | 28 | 30 | 26 | 30 |
| Post-fluorination | not applied | not applied | applied | used as |
| | | | | received |

Long chain branching calculations

| | | | | |
|---|---|---|---|---|
| η₀ [Pa · s] | 1380 | 2595 | 5310 | 1310 |
| lg(η₀ · ω₀) | 4.839 | 4.894 | 5.163 | — |
| Relaxation time τ₀ [s] | 0.020 | 0.033 | 0.036 | — |
| LCB size λ [kg/mol] | 248 | 285 | 292 | — |
| Peak amplitude a | 0.222 | 0.272 | 0.238 | — |
| LCB fraction [m/m %] | 3.3 | 3.6 | 3.4 | 0 |
| Parameter σ | 1.66 | 1.36 | 0.93 | — |
| dlg{G*(ω)}/dlg{ω} | 0.87 | 0.83 | 0.76 | 0.92 |

— = not determined

### Comparative Example 2 (CE-2)

A polymerization kettle with a total volume of 53 L equipped with an impeller agitator system was charged with 30.0 L deionized water and 240 g of a 30 weight % aqueous solution of perfluorooctanoate ammonium salt. The oxygen free kettle was then heated up to 70° C. and the agitation system was set to 210 rpm.

The polymerization kettle was first charged with 1750 g hexafluoropropene (HFP) to a pressure of 11 bar absolute, then the stainless steel cylinder with a total volume of 3.87 L used as feeding line for HFP was fully evacuated (150 mbar abs). After complete evacuation, the cylinder was charged to a pressure of 1.35 bar absolute with 1-bromo-2,2-difluoroethene (BDFE), which corresponds to 26.6 g at room temperature according to the ideal gas law. Then the cylinder was rapidly charged with 1290 g HFP in order to ensure a sufficient dispersion of BDFE into HFP under turbulent flow conditions. The polymerization was initiated by the addition of 38 g ammoniumperoxodisulfate (APS) in 100 mL deionized water. As the reaction started, the reaction temperature of 70° C. was maintained and the reaction pressure of 17 bar absolute was maintained by the feeding TFE and HFP into the gas phase with a feeding ratio HFP (kg)/TFE (kg) of 0.11. When a total feed of 10 kg TFE was reached in 275 min, the feed of the monomers was interrupted by closing the monomer valves. Then the reactor was vented and flushed with N₂ in three cycles. The so-obtained 40.6 kg polymer dispersion having a solid content of 27.9% and latex particles having 82 nm in diameter according to dynamic light scattering was discharged. After coagulation of the latex with hydrochloric acid, the polymer was agglomerated with gasoline, washed several times with deionized water and dried. The physical characteristics of the polymer are listed in Table 2 below.

Post fluorination: The dried polymer agglomerate was treated with elemental fluorine gas in a stainless steel fluorination reactor equipped with a gas inlet, a vent connection and a steam heating mantle. The polymer agglomerates were placed in the reactor, which was then sealed and the polymer was heated to 120° C. A vacuum was applied to the reactor to remove all air. The reactor was re-pressurized with nitrogen. This was repeated ten times, then a mixture of fluorine and nitrogen (10/90 volume %) was used to re-pressurize to 1 bar absolute. After 30 min the reactor was evacuated and re-pressured with the nitrogen/fluorine mixture. This was repeated 10 times. During the whole time, the temperature was maintained to 120° C. After the end of the fluorination, the reactor was purged several times with nitrogen to remove the fluorine and the polymer was cooled. The physical characteristics and long-chain branching values of the polymer are listed in Table 2 below.

### Comparative Example 3 (CE-3)

A copolymer of TFE and HFP was prepared as follows:

A copolymer was prepared in the same manner as in Comparative Example 2 except no 1-bromo-2,2-difluoroethene (BDFE) was used; the polymerization took 264 min. The physical characteristics of the dried polymer agglomerate are listed in Table 2 below.

TABLE 2

| | CE-2 | | CE-3 |
|---|---|---|---|
| Post-fluorination | not applied | applied | not applied |
| Melting point [° C.] | 257 | 257 | 248 |
| MFI(372/5) [g/10 min] | 22 | 13.4 | 2.0 |
| Number of unstable end-groups | 331 | 27 | 320 |

Long chain branching calculations

| | | | |
|---|---|---|---|
| η₀ at 372° C. [Pa · s] | ND | 4600 | ND |
| lg(η₀ · ω₀) | ND | 4.864 | ND |
| Relaxation time τ₀ [s] | ND | 0.063 | ND |
| LCB size λ [kg/mol] | ND | 341 | ND |
| Peak amplitude a | ND | 0.246 | ND |
| LCB fraction [m/m %] | ND | 3.4 | ND |
| Parameter σ | ND | 1.10 | ND |
| dlg{G*(ω)}/dlg{ω} | ND | 0.78 | ND |

ND = not determined

### Comparative Example 4 (CE-4)

A linear copolymer of TFE and PPVE-1 was prepared as follows:

A polymerization kettle with a total volume of about 53 L equipped with an impeller agitator system was charged with 30.0 L deionized water, and 210 g of a 30 wt. % aqueous solution of CF₃—O—(CF₂)₃—O—CFH—CF₂—COONH₄). The oxygen-free kettle was then heated up to 63° C. and the agitation system was set to 230 rpm. The kettle was charged with 110 mbar ethane and 200 g of perfluoropropylvinylether (PPVE-1). The kettle was then pressurized with 1100 g tetrafluoroethylene (TFE) to 13.0 bar absolute reaction pressure. The polymerization was initiated by the addition of 1.3 g ammonium persulfate. As the reaction started, the reaction temperature of 63° C. was maintained and the reaction pressure of 13.0 bar absolute was maintained by feeding TFE and PPVE-1 into the gas phase with monomer mass feed ratio and m_{PPVE-1}/M_{TFE} of 0.04. When a total feed of 12.2 kg TFE was reached in 277 min, the feed of the monomers was interrupted by closing the monomer valves. Then the reactor was vented and flushed with N₂ in three cycles.

The so-obtained 42.7 kg polymer dispersion having a solid content of 29.9 mass % was removed at the bottom of the reactor. 1000 g of the dispersion was subsequently agglomerated and dried for 16 h at 120° C. The thus obtained 0.3 kg polymer agglomerate showed the physical properties and long-chain branching values given in Table 3.

### Comparative Example 5 (CE-5)

A linear copolymer was prepared in the same manner as in Comparative Example 4 except that the kettle was pre-charged with 80 mbar ethane instead of 110 mbar, the other conditions were kept the same. The total feed of 12.2 kg TFE was reached in 256 min. The dry polymer agglomerate showed MFI (372/5) 1.2 g/10 min. The polymer was post-fluorinated according to the procedure as described in Comparative Example 2, and it then showed the physical properties and long-chain branching values summarized in Table 3.

### Example 4 (EX-4)

A copolymer of TFE, PPVE-1, and HPPVE-1 was prepared as follows:

A copolymer was prepared in the same manner as in Comparative Example 4 except that the PPVE-1 used in the pre-charge and the monomer feed was replaced by a blend of HPPVE-1 (10 wt %) diluted into PPVE-1 (90 wt %). This monomer blend was prepared by pre-charging HPPVE-1 in a stainless steel cylinder and vigorously filling up with PPVE-1 in order to ensure turbulent flow conditions and to provide good a mixing of the two individual components. The polymerization time took 282 min. The theoretical monomeric composition of the polymer is 96 wt % TFE, 3.6 wt % PPVE-1, and 0.4 wt % HPPVE-1. The physical properties and long-chain branching values of the dry polymer agglomerate before and after post-fluorination are shown in Table 3 below.

TABLE 3

| | EX-4 | | CE-4 | CE-5 |
|---|---|---|---|---|
| Post-fluorination | not applied | applied | not applied | applied |
| Melting point [° C.] | 313 | 313 | 313 | 307 |
| MFI(372/5) [g/10 min] | 1.6 | 1.2 | 2.3 | 1.1 |
| Number of unst. end-groups | 75 | 1 | 82 | 1 |

Long chain branching calculations

| | | | | |
|---|---|---|---|---|
| η₀ at 372° C. [Pa · s] | 57800 | 160000 | 14600 | 29700 |
| lg(η₀ · ω₀) | 5.088 | 5.424 | — | — |
| Relaxation time τ₀ [s] | 0.47 | 0.60 | — | — |
| LCB size λ [kg/mol] | 595 | 637 | — | — |
| Peak amplitude a | 1.323 | 1.298 | — | — |
| LCB fraction [m/m %] | 8.0 | 7.9 | 0 | 0 |
| Parameter σ | 1.81 | 1.34 | — | — |
| Polymer density [g/cm³] | Not | 2.142 | 2.139 | — |
| | determined | | | |
| dlg{G*(ω)}/d1g{ω} | 0.74 | 0.55 | 0.96 | 0.96 |

— means not applicable

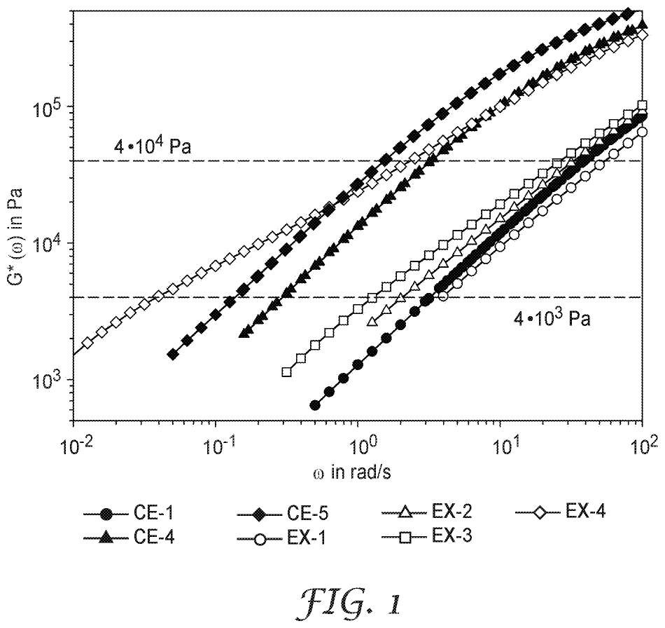

Examples 1 (not post-fluorinated), 2 (not post-fluorinated), 3 (post-fluorinated), and 4 (post-fluorinated) and Comparative Examples 1 (as received), 4 (not post-fluorinated) and 5 (post-fluorinated) were tested via dynamic mechanical testing and the log of G* versus the log of frequency (ω) were plotted in FIG. 1. The slope of each sample between 4×10³ Pa and 4×10⁴ Pa are shown in Table 4 below.

TABLE 4

| Sample | Post-fluorinated | Slope |
|---|---|---|
| EX-1 | No | 0.87 |
| EX-2 | No | 0.83 |
| EX-3 | Yes | 0.76 |
| EX-4 | Yes | 0.55 |
| CE-1 | Used as received | 0.92 |
| CE-4 | No | 0.96 |
| CE-5 | Yes | 0.96 |

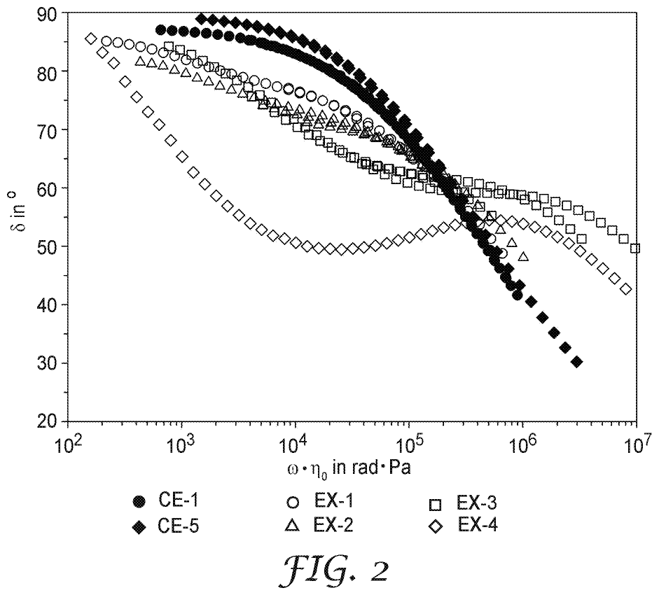

The rheology data was fit to the Carreau equation to determine the zero shear rate (η₀). The phase angle for each of the samples in Table 4 (except for CE-4) were plotted versus the frequency times the zero shear rate. The results are shown in FIG. 2. As shown in FIG. 2, CE-1 and CE-5 have similar profiles, while the curves for the Examples have differing slopes, inflection points, etc.

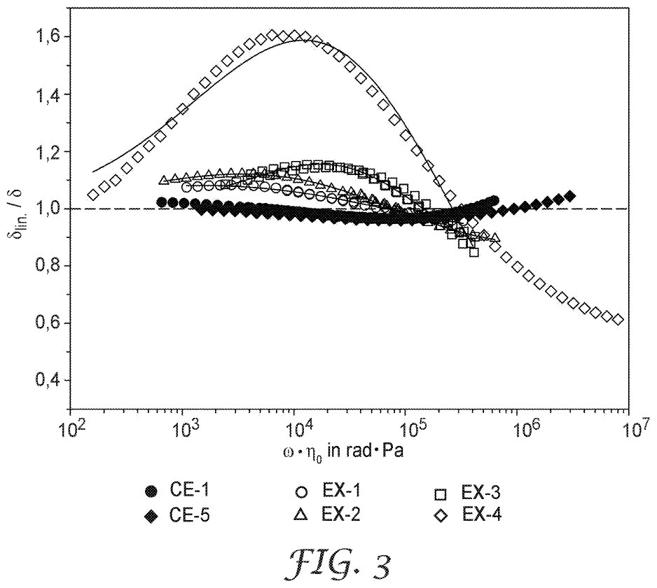

The phase shift for a linear polymer (δₗᵢₙ) was calculated using the equations described above in the Method of Determining Long Chain Branching. The observed phase shift (δ) was normalized versus the phase shift for a linear polymer (δₗᵢₙ) and plotted versus the frequency (ω) times the zero shear rate (η₀). The results for each of the samples in Table 4 (except for CE-4) are shown in FIG. 3 as data points. Also shown in FIG. 3, overlaid onto the normalized phase shift observed for each of the examples, is the theoretical (δₗᵢₙ/δ) versus (ω.η₀) taken from Equation 3. As shown in FIG. 3, the polymers of the present disclosure do not substantially have an (δₗᵢₙ/δ)=1, whereas the two comparative examples, appear to remain near (δₗᵢₙ/δ)=1.

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A fluorothermoplast derived from
(a) tetrafluoroethylene
(b) a perfluorinated olefin, wherein the perfluorinated olefin comprises at least one of hexafluoropropylene, perfluorinated vinyl ether, or a perfluorinated allyl ether;
(c) a modifier of the formula: F₂C═CF(CF₂)ₐ(O)RfH
wherein a is 0 or 1 and Rf is a linear or branched fluorinated alkylene group comprising 1 to 5 carbon atoms and optionally comprising at least one ether linkage and optionally comprising 1 or 2 hydrogen atoms.

2. The fluorothermoplast of claim 1, wherein the modifier has a boiling point less than 100° C.

3. The fluorothermoplast of claim 1, wherein the fluorothermoplast is derived from at least 0.01% and at most 1% by weight of the modifier.

4. The fluorothermoplast of claim 1, wherein the modifier comprises at least one of:
F₂C═CFO—CHF₂
F₂C═CFO—CF₂—CHF₂
F₂C═CFO—CF₂—CF₂—CHF₂
F₂C═CFO—CF₂—CF₂—CF₂—CHF₂
F₂C═CFO—CF₂—CF₂—CF₂—CF₂—CHF₂
F₂C═CFCF₂O—CHF₂
F₂C═CFCF₂O—CF₂—CHF₂
F₂C═CFCF₂O—CF₂—CF₂—CHF₂
F₂C═CFCF₂O—CF₂—CF₂—CF₂—CHF₂
F₂C═CFCF₂O—CF₂—CF₂—CF₂—CF₂—CHF₂
F₂C═CFO—CF₂—CF₂—O—CF₂CHF₂ and
F₂C═CF—CF₂—CF₂—CHF₂.

5. The fluorothermoplast of claim 1, wherein the fluorothermoplast is substantially free of bromine, chlorine and iodine.

6. The fluorothermoplast of claim 1, wherein the fluorothermoplast is a perfluoroalkoxy polymer (PFA) or a fluorinated ethylene-propylene polymer (FEP).

7. The fluorothermoplast of claim 1, wherein the fluorothermoplast consists essentially of tetrafluoroethylene, the perfluorinated olefin, and the modifier.

8. The fluorothermoplast of claim 1, wherein the fluorothermoplast comprises less than 50 thermally unstable end groups per 1 million carbon atoms.

9. The fluorothermoplast of claim 1, wherein the fluorothermoplast is substantially free of alkali and alkaline earth metals.

10. A composition comprising the fluorothermoplast of claim 1.

11. A perfluorinated fluorothermoplast comprising long chain branching, wherein the perfluorinated fluorothermoplast has a relaxation exponent from 0.3 to 0.85.

12. The fluorothermoplast of claim 1, wherein the fluorothermoplast has a melting point of between 100° C. and 320° C.

13. The fluorothermoplast of claim 1, wherein the fluorothermoplast comprises at least 65% fluorine by weight compared to the total weight of the fluorothermoplast.

14. The fluorothermoplast of claim 1, wherein Rf is a linear or branched perfluorinated alkylene group comprising 1 to 5 carbon atoms and optionally comprising at least one ether linkage.

15. The fluorothermoplast of claim 1, wherein when the complex modulus G*(ω) measured at 372° C. over 4×10³ Pa to 4×10⁴ Pa is plotted versus the angular frequency (ω) for the fluorothermoplast having an MFI of less than 50 g/10 min measured at 372° C. with 5.0 kg weight, the slope of the log of the complex modulus G*(ω) versus the log of the angular frequency (ω) is no more than 0.90 (dlogG*(ω))/dlogω).

16. The fluorothermoplast of claim 1, wherein the fluorothermoplast is substantially free of alkali and alkaline earth metals.

17. A method of making a fluorothermoplast comprising:
(a) polymerizing tetrafluoroethylene and a perfluorinated olefin in an aqueous solution comprising a fluorinated emulsifier, wherein the perfluorinated olefin comprises at least one of hexafluoropropylene, perfluorinated vinyl ether, or a perfluorinated allyl ether to form the fluorothermoplast;
(b) at least semi-continuously adding a modifier during the polymerization, wherein the modifier is of the formula: F₂C═CF(CF₂)ₐ(O)RfH
wherein a is 0 or 1 and Rf is a linear or branch fluorinated alkyl group having at most 1 or 2 hydrogen atoms and optionally comprising an ether linkage and wherein Rf comprises at least one and no more than 5 carbon atoms; and
(c) isolating the fluorothermoplast; and
(d) optionally, post-fluorinating the isolated fluorothermoplast.

18. The method of claim 17, wherein the modifier has a boiling point less than 100° C.

19. The method of claim 17, wherein the modifier comprises at least one of:
F₂C═CFO—CHF₂
F₂C═CFO—CF₂—CHF₂
F₂C═CFO—CF₂—CF₂—CHF₂
F₂C═CFO—CF₂—CF₂—CF₂—CHF₂
F₂C═CFO—CF₂—CF₂—CF₂—CF₂—CHF₂
F₂C═CFCF₂O—CHF₂
F₂C═CFCF₂O—CF₂—CHF₂
F₂C═CFCF₂O—CF₂—CF₂—CHF₂
F₂C═CFCF₂O—CF₂—CF₂—CF₂—CHF₂
F₂C═CFCF₂O—CF₂—CF₂—CF₂—CF₂—CHF₂
F₂C═CFO—CF₂—CF₂—O—CF₂CHF₂ and
F₂C═CF—CF₂—CF₂—CHF₂.

20. The method of claim 17, wherein the polymerizing step consists essentially of tetrafluoroethylene, the perfluorinated olefin, and the modifier.
